(19) United States
(12) Patent Application Publication
(10) Pub. No.: US 2024/0186775 A1
(43) Pub. Date: Jun. 6, 2024

(54) CORRUGATED TUBE AND WIRE HARNESS

(71) Applicant: YAZAKI CORPORATION, Tokyo (JP)

(72) Inventors: Hirotaka Kiyota, Makinohara-shi (JP); Masaru Kiuchi, Makinohara-shi (JP)

(21) Appl. No.: 18/437,096

(22) Filed: Feb. 8, 2024

Related U.S. Application Data
(63) Continuation of application No. PCT/JP2022/047030, filed on Dec. 21, 2022.

(30) Foreign Application Priority Data
Jan. 26, 2022 (JP) 2022-009841

(51) Int. Cl. H02G 3/04; H01B 7/00

(52) U.S. Cl. CPC H02G 3/0468; H01B 7/0045

(57) ABSTRACT

A corrugated tube includes an outer layer structure having a tubular shape and serving as a layer portion on an outer side, an intermediate layer structure having a tubular shape and serving as a layer portion on an inner side of the outer layer structure, and an inner layer structure having a tubular shape and serving as a layer portion on an inner side of the intermediate layer structure, in which an electric wire can be accommodated inside, and the outer layer structure, the intermediate layer structure, and the inner layer structure are arranged in close contact with one another and are arranged to be freely movable relative to one another.

### CROSS-REFERENCE TO RELATED APPLICATION

This application is a continuation application of International Application No. PCT/JP2022/047030 filed on Dec. 21, 2022 which claims the benefit of priority from Japanese Patent Application No. 2022-009841 filed on Jan. 26, 2022 and designating the U.S., the entire contents of which are incorporated herein by reference.

### BACKGROUND OF THE INVENTION

### 1. Field of the Invention

The present invention relates to a corrugated tube and a wire harness.

### 2. Description of the Related Art

In automobiles, wire harnesses are used to electrically connect various devices installed in the automobiles. A wire harness includes an exterior member having a tubular shape and electric wires accommodated in the exterior member. A corrugated tube is applied to the exterior member, and protects the electric wires accommodated therein.

The corrugated tube may have a multilayer structure. The multilayer structure of the corrugated tube has, for example, an outer layer structure, an intermediate layer structure, and an inner layer structure. Such a corrugated tube is disclosed in Japanese Patent Application Laid-open No. 2018-143019.

In the multilayer structure forming the corrugated tube, the outer layer structure, the intermediate layer structure, and the inner layer structure adhere to one another so that the layer structures do not shift from one another. A conventional corrugated tube effectively absorbs impact force by different deformation of the outer layer structure, the intermediate layer structure, and the inner layer structure as the multilayer structure when external force is applied. In recent years, corrugated tubes have been required to improve a function of absorbing impact force from the outside.

### SUMMARY OF THE INVENTION

An object of the present invention is to provide a corrugated tube and a wire harness that can improve an impact force absorbing function.

The corrugated tube according to one aspect of the present invention includes: a first layer structure having a tubular shape and serving as a layer portion on an outer side; and a second layer structure having a tubular shape and serving as a layer portion on an inner side of the first layer structure, wherein an electric wire is able to be accommodated inside, and the first layer structure and the second layer structure are arranged in close contact with each other and are arranged to be freely movable relative to each other.

The wire harness according to another aspect of the present invention includes: the corrugated tube; and one or more electric wires accommodated in the corrugated tube.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a wire harness according to an embodiment;

FIG. 2 is a sectional view of a corrugated tube according to the embodiment;

FIG. 3 is a sectional view of main parts of the corrugated tube according to the embodiment;

FIG. 4 is a schematic view illustrating combinations of materials applied to an outer layer structure, an intermediate layer structure, and an inner layer structure;

FIG. 5 is an explanatory view of a first example illustrating specific combinations of the materials applied to the outer layer structure, the intermediate layer structure, and the inner layer structure;

FIG. 6 is an explanatory view of a second example illustrating specific combinations of the materials applied to the outer layer structure, the intermediate layer structure, and the inner layer structure;

FIG. 7 is a sectional view of main parts before external force is applied to a corrugated tube;

FIG. 8 is a sectional view of main parts when external force is applied to a conventional corrugated tube; and

FIG. 9 is a sectional view of main parts when external force is applied to the corrugated tube of the embodiment.

### DETAILED DESCRIPTION OF THE PREFERRED EMBODIMENTS

A corrugated tube according to an embodiment of the present invention is described below with reference to the drawings. This invention is not limited by this embodiment. The components in the following embodiment include those that can be readily assumed by those skilled in the art or are substantially the same.

### EMBODIMENT

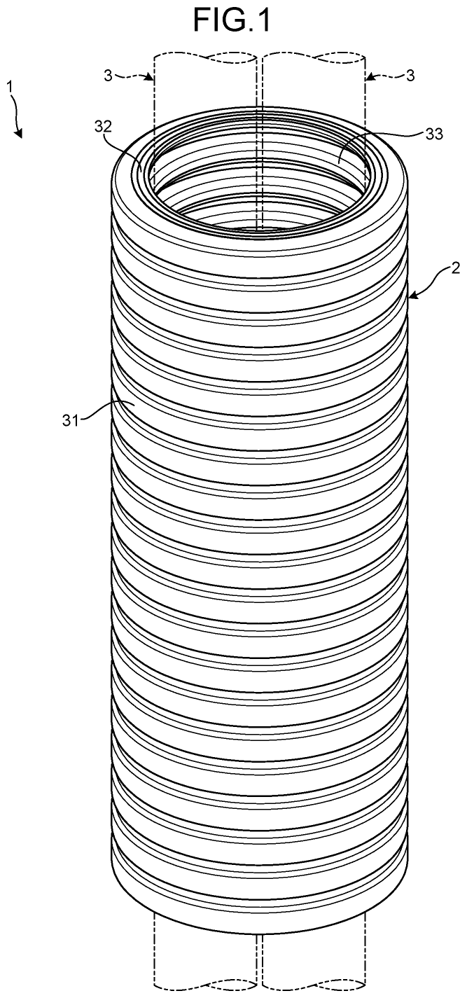

An embodiment is described with reference to the drawings. The present embodiment relates to a corrugated tube and a wire harness. FIG. 1 is a perspective view of a wire harness according to the embodiment.

As illustrated in FIG. 1, a wire harness 1 includes a corrugated tube 2 and electric wires 3. The corrugated tube 2 has a cylindrical shape and accommodates the electric wires 3 therein. In the present example, the corrugated tube 2 accommodates two electric wires 3, but the number of electric wires 3 is not limited.

The corrugated tube 2 is used, for example, as an exterior member for protecting the electric wires 3 installed in a vehicle such as an automobile from the outside. Each of the electric wires 3 has a conductor portion (core wire) made of a plurality of conductive metal strands and an insulating coated portion covering the outside of the conductor. The coated portion of the electric wire 3 is, for example, layered on the outermost layer of the electric wire 3.

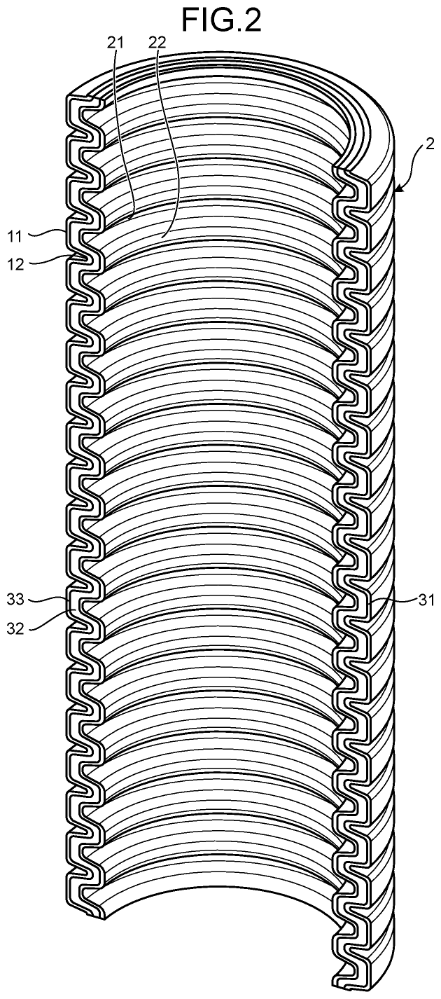

FIG. 2 is a sectional view of the corrugated tube according to the embodiment.

As illustrated in FIG. 2, the corrugated tube 2 is flexible. The corrugated tube 2 is formed in a bellows tube shape. However, the corrugated tube 2 is not limited to a bellows shape, but may have a straight, oval, or polygonal tubular shape, for example. The corrugated tube 2 is formed in a shape having an outer surface convex portion 11 along a circumferential direction and an outer surface concave portion 12 along the circumferential direction when viewed from an outer surface side. The corrugated tube 2 is formed in a shape in which the outer surface convex portion 11 and the outer surface concave portion 12 alternately disposed continuously in an axial direction. The corrugated tube 2 is formed in a shape having an inner surface concave portion 21 along the circumferential direction and an inner surface convex portion 22 along the circumferential direction when viewed from an inner surface side. The corrugated tube 2 is formed in a shape in which the inner surface concave portion 21 and the inner surface convex portion 22 alternately disposed continuously in the axial direction.

In the corrugated tube 2, the outer surface convex portion 11 and the inner surface concave portion 21 face each other in a radial direction, and the outer surface concave portion 12 and the inner surface convex portion 22 face each other in the radial direction.

The corrugated tube 2 has a multilayer structure. The corrugated tube 2 has an outer layer structure 31, an intermediate layer structure 32, and an inner layer structure 33. The outer layer structure 31, the intermediate layer structure 32, and the inner layer structure 33 are arranged in close contact with one another without gaps between the layer structures and are arranged to be freely movable relative to one another. That is, the outer layer structure 31, the intermediate layer structure 32, and the inner layer structure 33 are formed so that the layer structures are in close contact with one another without gaps, but can be shifted among the layer structures.

In the relationship between the outer layer structure 31 and the intermediate layer structure 32, the outer layer structure 31 located at the outer side of the corrugated tube 2 forms a “first layer structure” and the intermediate layer structure 32 located at the inner side of the corrugated tube 2 forms a “second layer structure”. In the relationship between the intermediate layer structure 32 and the inner layer structure 33, the intermediate layer structure 32 located at the outer side of the corrugated tube 2 forms the “first layer structure” and the inner layer structure 33 located at the inner side of the corrugated tube 2 forms the “second layer structure”. However, the corrugated tube 2 is not limited to having the outer layer structure 31, the intermediate layer structure 32, and the inner layer structure 33. For example, the corrugated tube 2 may also be constituted by the outer layer structure 31 and the inner layer structure 33. In this case, in the corrugated tube 2, the outer layer structure 31 located at the outer side of the corrugated tube 2 forms the “first layer structure” and the inner layer structure 33 located at the inner side of the corrugated tube 2 forms the “second layer structure”. The corrugated tube 2 may also be constituted by the outer layer structure 31, a plurality of the intermediate layer structures 32, and the inner layer structure 33. In this case, in the corrugated tube 2, the layer structure located at the outer side out of the two layer structures in close contact with each other forms the “first layer structure” and the layer structure located at the inner side out of the two layer structures forms the “second layer structure”.

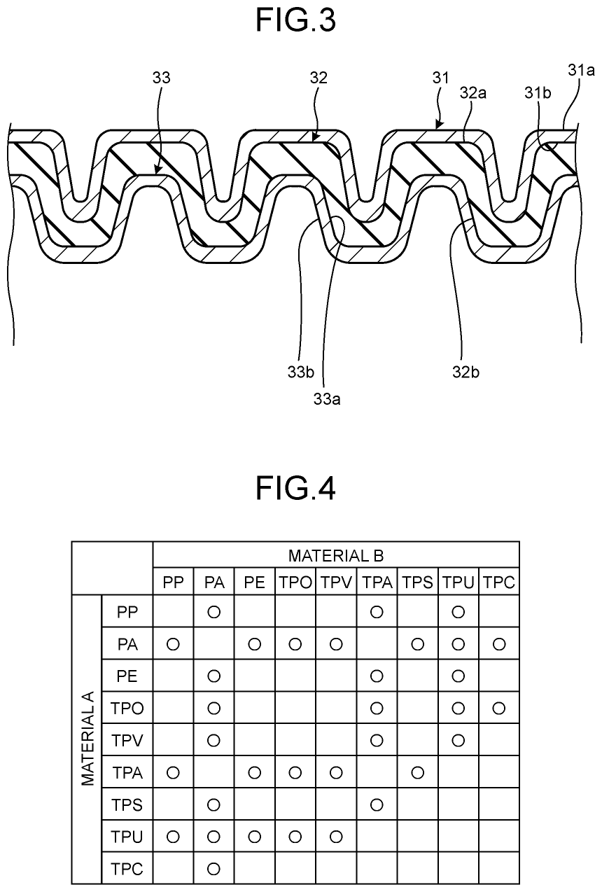

FIG. 3 is a sectional view of main parts of the corrugated tube according to the embodiment.

As illustrated in FIG. 3, the corrugated tube 2 is configured by layering the outer layer structure 31, the intermediate layer structure 32, and the inner layer structure 33 from the outside. The corrugated tube 2 is formed by the outer surface convex portion 11 and the outer surface concave portion 12 alternately disposed continuously in the axial direction, and is formed by the inner surface concave portion 21 and the inner surface convex portion 22 alternately disposed continuously in the axial direction. The outer layer structure 31 and the inner layer structure 33 are set to have approximately the same thickness, and the intermediate layer structure 32 is set to be thicker than the outer layer structure 31 and the inner layer structure 33. However, the thickness relationship among the outer layer structure 31, the intermediate layer structure 32, and the inner layer structure 33 is not limited to the relationship described above.

The outer layer structure 31 is arranged at the outermost side in the corrugated tube 2. In the outer layer structure 31, an outer surface 31a is exposed to the outside and an inner surface 31b is in close contact with an outer surface 32a of the intermediate layer structure 32. The outer layer structure 31 is formed using a harder material (hard material) than the intermediate layer structure 32. The material to be applied is appropriately selected to have a function of collision resistance (impact resistance and strength increase). The material may be capable of providing not only the function of collision resistance but also other functions required for the wire harness 1 such as heat dissipation and heat resistance.

The inner layer structure 33 is arranged at the innermost side in the corrugated tube 2. In the inner layer structure 33, an outer surface 33a is in close contact with an inner surface 32b of the intermediate layer structure 32, and an inner surface 33b is exposed to the inside. Similarly to the outer layer structure 31, the inner layer structure 33 is formed using a harder material (hard material) than the intermediate layer structure 32. The material to be applied is appropriately selected similarly to the outer layer structure 31.

The intermediate layer structure 32 is arranged at an intermediate position in the thickness direction of the corrugated tube 2, that is, between the outer layer structure 31 and the inner layer structure 33. In the intermediate layer structure 32, the outer surface 32a is in close contact with the inner surface 31b of the outer layer structure 31 and the inner surface 32b is in close contact with the outer surface 33a of the inner layer structure 33. The intermediate layer structure 32 is formed using a softer material (soft material) than the outer layer structure 31 and the inner layer structure 33. The material to be applied is appropriately selected to have a shock absorbing function.

In the corrugated tube 2, the outer layer structure 31 and the inner layer structure 33 are formed using a hard material, and the intermediate layer structure 32 is formed using a soft material. In the corrugated tube 2, the outer layer structure 31 may be formed using a hard material, and the intermediate layer structure 32 and the inner layer structure 33 may be formed using a soft material. When the corrugated tube 2 is constituted by the outer layer structure 31 and the inner layer structure 33, the outer layer structure 31 is formed using a hard material and the inner layer structure 33 is formed using a soft material.

In the corrugated tube 2, for example, when external force acts, the outer layer structure 31 and the inner layer structure 33 exhibits an impact resistance function and the intermediate layer structure 32 exhibits a shock absorbing function.

Specific materials of the outer layer structure 31, the intermediate layer structure 32, and the inner layer structure 33 constituting the corrugated tube 2 are described below. FIG. 4 is a schematic view illustrating combinations of materials applied to the outer layer structure, the intermediate layer structure, and the inner layer structure.

In the corrugated tube 2 described above, the outer layer structure 31, the intermediate layer structure 32, and the inner layer structure 33 are arranged in close contact with one another without gaps between the layer structures, and are arranged to be freely movable relative to one another. The direction of relative movement among the outer layer structure 31, the intermediate layer structure 32, and the inner layer structure 33 is mainly an in-plane direction.

Although not illustrated in the drawings, the corrugated tube 2 is manufactured by extrusion molding. For example, first, a tubular member in which the materials of the outer layer structure 31, the intermediate layer structure 32, and the inner layer structure 33 are layered in the thickness direction is extruded and formed by an extruder. Second, a molding machine swells the tubular member and presses the tubular member against upper and lower molds, whereby a bellows member is formed and cooled. Subsequently, the bellows member is stretched by a pulling machine, and then is wound by a winder or cut by a cutter.

At this time, when the materials of the outer layer structure 31, the intermediate layer structure 32, and the inner layer structure 33 are of the same or similar type, the materials melted by heating in the extruder are welded together. For example, when the materials of the outer layer structure 31, the intermediate layer structure 32, and the inner layer structure 33 are the same or close type, the molten materials diffuse into one another and molecular chains are intertwined and weld together. Therefore, the outer layer structure 31, the intermediate layer structure 32, and the inner layer structure 33 are brought into a closely adhering state.

In the corrugated tube 2 of the present embodiment, the outer layer structure 31, the intermediate layer structure 32, and the inner layer structure 33 are in close contact with one another without gaps between the layer structures, but are arranged to be freely movable relative to one another. That is, the types of the materials of the outer layer structure 31, the intermediate layer structure 32, and the inner layer structure 33 are made different, so that molten materials do not diffuse into one another and molecular chains are not intertwined.

Specifically, SP values (dissolution parameters) of the materials applied to the outer layer structure 31, the intermediate layer structure 32, and the inner layer structure 33 are made different from one another. Preferably, a material in which the difference between the SP value of the material applied to the outer layer structure 31 and the SP value of the material applied to the intermediate layer structure 32 is 1.5 or more is used. Preferably, a material in which the difference between the SP value of the material applied to the intermediate layer structure 32 and the SP value of the material applied to the inner layer structure 33 is 1.5 or more is used. A combination of materials in which the difference in the SP values is less than 1.5 is likely to cause welding among the layers.

The table in FIG. 4 illustrates appropriate combinations of materials in which the difference in the SP values is 1.5 or more. In this case, when a material A is applied to the outer layer structure 31, a material B is appropriate for the intermediate layer structure 32, and when the material A is applied to the intermediate layer structure 32, the material B is appropriate for the inner layer structure 33. In FIG. 4, “₀” indicates a combination of materials in which the difference in the SP values is 1.5 or more.

As illustrated in FIG. 4, candidates for the materials A and B include polypropylene resin (PP), polyamide resin (PA), polyethylene (PE), olefinic thermoplastic elastomer (TPO), dynamic crosslinked thermoplastic elastomer (TPV), amide thermoplastic elastomer (TPA), styrene thermoplastic elastomer (TPS), polyurethane thermoplastic elastomer (TPU), and polyester thermoplastic elastomer (TPC), but are not limited thereto.

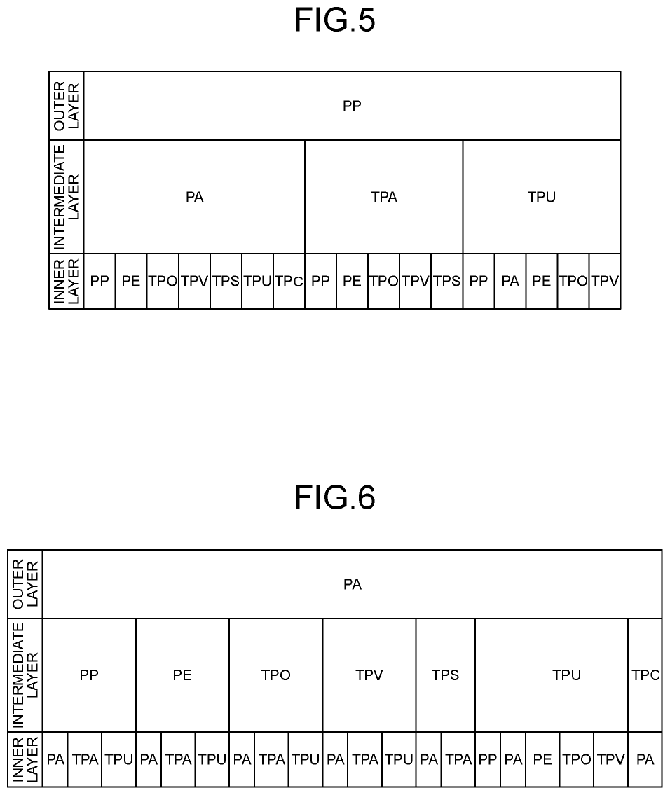

Specific examples of the materials applied to the outer layer structure 31, the intermediate layer structure 32 and the inner layer structure 33 are described below. FIG. 5 is an explanatory view of a first example illustrating specific combinations of the materials applied to the outer layer structure, the intermediate layer structure, and the inner layer structure.

The table in FIG. 5 illustrates materials appropriate for the intermediate layer structure 32 and the inner layer structure 33 when PP is applied as the material of the outer layer structure 31. As illustrated in FIG. 5, when PP is applied as the material of the outer layer structure 31, PA, TPA, and TPU are materials appropriate for the intermediate layer structure 32. When PA is applied as the material of the intermediate layer structure 32, PP, PE, TPO, TPV, TPS, TPU, and TPC are materials appropriate for the inner layer structure 33. When TPA is applied as the material of the intermediate layer structure 32, PP, PE, TPO, TPV, and TPS are materials appropriate for the inner layer structure 33. When TPU is applied as the material of the intermediate layer structure 32, PP, PA, PE, TPO, and TPV are materials appropriate for the inner layer structure 33.

FIG. 6 is an explanatory view of a second example illustrating specific combinations of the materials applied to the outer layer structure, the intermediate layer structure, and the inner layer structure.

The table in FIG. 6 illustrates materials appropriate for the intermediate layer structure 32 and the inner layer structure 33 when PA is applied as the material of the outer layer structure 31. As illustrated in FIG. 6, when PA is applied as the material of the outer layer structure 31, PP, PE, TPO, TPV, TPS, and TPU are materials appropriate for the intermediate layer structure 32. When PP is applied as the material of the intermediate layer structure 32, PA, TPA, and TPU are materials appropriate for the inner layer structure 33. When PE is applied as the material of the intermediate layer structure 32, PA, TPA, and TPU are materials appropriate for the inner layer structure 33. When TPO is applied as the material of the intermediate layer structure 32, PA, TPA, and TPU are materials appropriate for the inner layer structure 33. When TPV is applied as the material of the intermediate layer structure 32, PA, TPA, and TPU are materials appropriate for the inner layer structure 33. When TPS is applied as the material of the intermediate layer structure 32, PA and TPA are materials appropriate for the inner layer structure 33. When TPU is applied as the material of the intermediate layer structure 32, PP, PA, PE, TPO, and TPV are materials appropriate for the inner layer structure 33. When TPC is applied as the material of the intermediate layer structure 32, PA is a material appropriate for the inner layer structure 33.

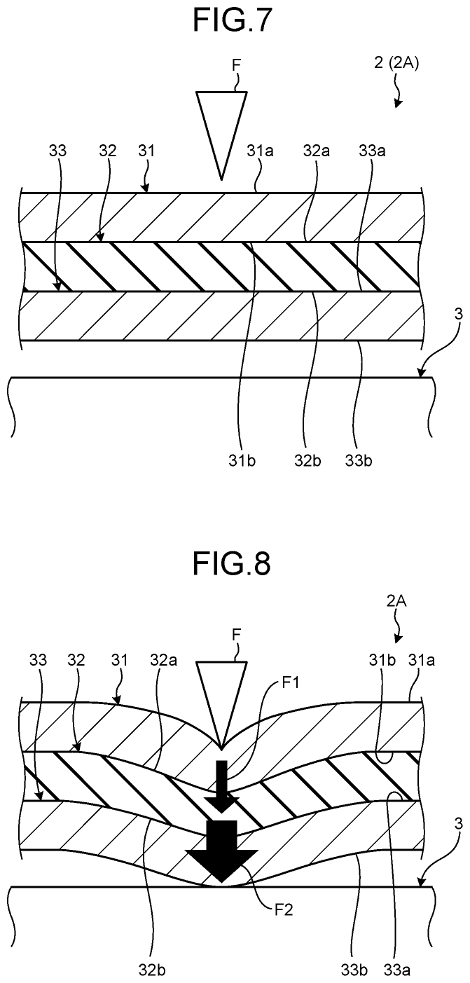

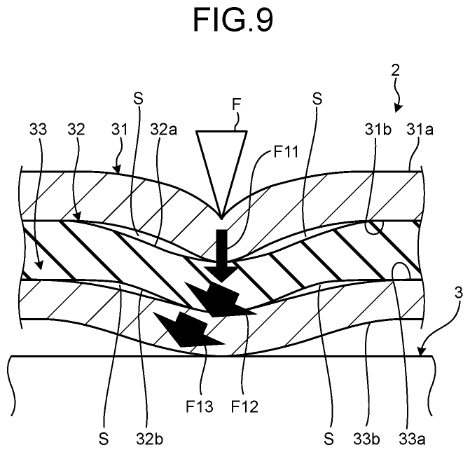

An operation of the corrugated tube 2 of the present embodiment is described below. FIG. 7 is a sectional view of main parts before external force is applied to a corrugated tube, FIG. 8 is a sectional view of main parts when external force is applied to a conventional corrugated tube, and FIG. 9 is a sectional view of main parts when external force is applied to the corrugated tube of the embodiment.

As illustrated in FIG. 7, in the corrugated tube 2, an outer layer structure 31, an intermediate layer structure 32, and an inner layer structure 33 are arranged in close contact with one another. The behavior of the outer layer structure 31, the intermediate layer structure 32, and the inner layer structure 33 when external force F acts on the corrugated tube 2 is described. The external force F is input in a direction orthogonal to the outer surface 31a of the outer layer structure 31. The external force F is assumed to be applied to the outer surface 31a of the outer layer structure 31 at a point or a line.

As illustrated in FIG. 8, a conventional corrugated tube 2A has a structure in which an outer layer structure 31, an intermediate layer structure 32, and an inner layer structure 33 are in close contact with one another and are arranged in an adhering state. That is, the conventional corrugated tube 2A has a structure in which the outer layer structure 31, the intermediate layer structure 32, and the inner layer structure 33 are arranged not to be movable relative to one another. In this case, when external force F acts on an outer surface 31a of the outer layer structure 31, a deformation of the outer surface 31a of the outer layer structure 31 and a deformation of an inner surface 33b of the inner layer structure 33 are in offset. At this time, the deformation of the inner surface 33b of the inner layer structure 33 is more moderate than the deformation of the outer surface 31a of the outer layer structure 31. Therefore, the inner layer structure 33 of the corrugated tube 2A is in a state in which the inner surface 33b can be brought into substantially surface contact with an outer surface of an electric wire 3 (surface contact state).

That is, in the conventional corrugated tube 2A, the outer layer structure 31 is deformed by the input of the external force F, and the intermediate layer structure 32 is collapsed accordingly, and the impact force (external force F) is absorbed to some extent by this collapse. Subsequently, the inner layer structure 33 is deformed more moderately than the outer layer structure 31 as the intermediate layer structure 32 is deformed. That is, the deformation of the outer surface 31a of the outer layer structure 31 and the deformation of the inner surface 33b of the inner layer structure 33 become different from each other, and the inner surface 33b of the inner layer structure 33 can be brought into surface contact with the electric wire 3. At this time, the external force F acting on the outer layer structure 31 becomes transmission forces F1 and F2 transmitted in a direction orthogonal to the outer layer structure 31, the intermediate layer structure 32, and the inner layer structure 33, and the inner surface 33b of the inner layer structure 33 enters a surface contact state in which impact force acts in a direction orthogonal to the outer surface of the electric wire 3.

On the other hand, as illustrated in FIG. 9, the corrugated tube 2 of the present embodiment has a structure in which the outer layer structure 31, the intermediate layer structure 32, and the inner layer structure 33 are in close contact with one another, but are arranged to be freely movable relative to one another. In this case, when external force F acts on the outer surface 31a of the outer layer structure 31, a deformation of the outer surface 31a of the outer layer structure 31 and a deformation of the inner surface 33b of the inner layer structure 33 are not in offset. At this time, the deformation of the inner surface 33b of the inner layer structure 33 is more moderate than the deformation of the outer surface 31a of the outer layer structure 31. Therefore, the inner layer structure 33 of the corrugated tube 2 is in a state in which the inner surface 33b can be brought into substantially surface contact with an outer surface of the electric wire 3 (surface contact state).

That is, in the corrugated tube 2 of the present embodiment, the outer layer structure 31 is deformed by the input of the external force F, and the intermediate layer structure 32 is collapsed accordingly, and the impact force (external force F) is absorbed to some extent by this collapse. Subsequently, the inner layer structure 33 is deformed more moderately than the outer layer structure 31 as the intermediate layer structure 32 is deformed. At this time, the inner surface 31b of the outer layer structure 31 and the outer surface 32a of the intermediate layer structure 32 move relative to each other, and the inner surface 32b of the intermediate layer structure 32 and the outer surface 33a of the inner layer structure 33 move relative to each other. That is, the deformation direction of the outer layer structure 31, the deformation direction of the intermediate layer structure 32, and the deformation direction of the inner layer structure 33 are different directions, making it easier to form cavities S between the layers. At this time, the external force F acting in a direction orthogonal to the outer layer structure 31 becomes transmission force F11 transmitted in the direction orthogonal to the outer layer structure 31, and becomes transmission force F12 transmitted in a direction inclined to the orthogonal direction at the intermediate layer structure 32. Subsequently, the transmission force F12 becomes transmission force F13 transmitted in a direction inclined to the orthogonal direction at the inner layer structure 33. The inner surface 33b of the inner layer structure 33 is in a surface contact state in which the impact force acts in a direction that is inclined, not orthogonal, to the outer surface of the electric wire 3. Therefore, the impact force acting on the electric wire 3 from the inner layer structure 33 is mitigated, and the corrugated tube 2 is not damaged and does not lead to disconnection or electrical leakage of the electric wire 3.

As described above, the corrugated tube 2 according to the present embodiment includes the outer layer structure 31 having a tubular shape and serving as a layer portion on the outer side, the intermediate layer structure 32 having a tubular shape and serving as a layer portion on the inner side of the outer layer structure 31, and the inner layer structure 33 having a tubular shape and serving as a layer portion on the inner side of the intermediate layer structure 32, in which the electric wire 3 can be accommodate inside, and the outer layer structure 31, the intermediate layer structure 32, and the inner layer structure 33 are arranged in close contact with one another and are arranged to be freely movable relative to one another.

According to the corrugated tube 2 of the present embodiment, the outer layer structure 31, the intermediate layer structure 32, and the inner layer structure 33 are arranged to be freely movable relative to one another. Therefore, when the external force F acts on the outer surface 31a of the outer layer structure 31, the outer layer structure 31, the intermediate layer structure 32, and the inner layer structure 33 move relative to one another, and the deformation directions of the outer layer structure 31, the intermediate layer structure 32, and the inner layer structure 33 are different from one another. Consequently, the inner layer structure 33 enters a surface contact state in which impact force acts in a direction inclined to the electric wire 3, and the impact force acting on the electric wire 3 can be mitigated. As a result, an impact force absorbing function can be improved.

The corrugated tube 2 of the present embodiment is formed so that when the external force F acts on the outer surface 31a of the outer layer structure 31, the deformation of the outer surface 31a of the outer layer structure 31 and the deformation of the inner surface 33b of the inner layer structure 33 are in offset. Therefore, the deformation directions of the outer layer structure 31 and the inner layer structure 33 differ with respect to the external force F, and the transmission force F13 transmitted from the outer layer structure 31 to the inner layer structure 33 can be mitigated.

In the corrugated tube 2 of the present embodiment, when the external force F acts on the outer surface 31a of the outer layer structure 31, impact force is transmitted in a direction inclined to the inner surface 33b of the inner layer structure 33 due to the relative movement of contact surfaces of the outer layer structure 31, the intermediate layer structure 32, and the inner layer structure 33. Therefore, the impact force acting on the electric wire 3 from the inner layer structure 33 is mitigated when the impact force acts in the inclined direction rather than in the orthogonal direction, so that the impact force acting on the electric wire 3 can be reduced.

The wire harness 1 of the present embodiment includes the corrugated tube 2 and one or more electric wires 3 accommodated in the corrugated tube 2. Therefore, an impact force absorbing function can be improved by mitigating impact force acting on the electric wire 3.

The contents disclosed in the above embodiment and modifications can be combined and implemented as appropriate.

A corrugated tube and a wire harness according to the present embodiments have an effect that can improve an impact force absorbing function.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A corrugated tube comprising:
a first layer structure having a tubular shape and serving as a layer portion on an outer side; and
a second layer structure having a tubular shape and serving as a layer portion on an inner side of the first layer structure, wherein
an electric wire is able to be accommodated inside, and
the first layer structure and the second layer structure are arranged in close contact with each other and are arranged to be freely movable relative to each other.

2. The corrugated tube according to claim 1, wherein,
when external force acts on an outer surface of the first layer structure, a deformation of the outer surface of the first layer structure and a deformation of an inner surface of the second layer structure are not in offset.

3. The corrugated tube according to claim 1, wherein,
when external force acts on an outer surface of the first layer structure, impact force is transmitted in a direction inclined to an inner surface of the second layer structure due to a relative movement of contact surfaces of the first layer structure and the second layer structure.

4. The corrugated tube according to claim 2, wherein,
when external force acts on an outer surface of the first layer structure, impact force is transmitted in a direction inclined to an inner surface of the second layer structure due to a relative movement of contact surfaces of the first layer structure and the second layer structure.

5. A wire harness comprising:
the corrugated tube according to claim 1; and
one or more electric wires accommodated in the corrugated tube.

6. A wire harness comprising:
the corrugated tube according to claim 2; and
one or more electric wires accommodated in the corrugated tube.

7. A wire harness comprising:
the corrugated tube according to claim 3; and
one or more electric wires accommodated in the corrugated tube.

8. A wire harness comprising:
the corrugated tube according to claim 4; and
one or more electric wires accommodated in the corrugated tube.
